(19) United States
(12) Patent Application Publication
(10) Pub. No.: US 2025/0115377 A1
(43) Pub. Date: Apr. 10, 2025

(54) INFORMATION PROCESSING DEVICE, CALCULATION METHOD, AND STORAGE MEDIUM

(71) Applicant: NEC Corporation, Minato-ku, Tokyo (JP)

(72) Inventors: Jun Yoshida, Tokyo (JP); Makoto Tanaka, Tokyo (JP); Masatoshi Ebara, Tokyo (JP)

(73) Assignee: NEC Corporation, Minato-ku, Tokyo (JP)

(21) Appl. No.: 18/729,954

(22) PCT Filed: Mar. 25, 2022
(86) PCT No.: PCT/JP2022/014405

§ 371 Date: Jul. 18, 2024

(51) Int. Cl. B64G 3/00

(52) U.S. Cl. CPC B64G 3/00

(57) ABSTRACT

The information processing device 2X includes a data acquisition means 32X and an abnormality degree calculation means 33X. The data acquisition means 32X is configured to acquire time series data which represents a luminous intensity of a space object. The abnormality degree calculation means 33X is configured to calculate, based on the time series data, an abnormality degree regarding a state of the space object.

### TECHNICAL FIELD

The present disclosure relates to a technical field of an information processing device, a calculation method, and a storage medium configured to perform processing related to change detection of a space object.

### BACKGROUND

There is a technology on detecting abnormality of a space object such as an artificial satellite. For example, Patent Literature 1 discloses a monitoring system configured to detect, an abnormality of the posture and/or shape of a target object, which is an artifact orbiting the earth, based on the periodicity of the luminous intensity of the target object, through comparison between the luminous intensity information of the target object and the luminous intensity information of a reference star to correct the luminous intensity information of the target object.

### CITATION LIST

### Patent Literature

Patent Literature 1: JP 2015-202809A

### SUMMARY

### Problem to be Solved

In the abnormality detection method described in Patent Literature 1, selection of the reference star and selection of the luminous intensity other than the target object greatly affects the subsequent processing, which needs skilled technicians for dealing properly with the selections.

In view of the above-described issue, it is therefore an example object of the present disclosure to provide an information processing device, a calculation method, and a storage medium capable of performing processing for suitably detecting a change in a space object.

### Means for Solving the Problem

One aspect of the information processing device is an information processing device including:
a data acquisition means configured to acquire time series data which represents a luminous intensity of a space object; and
an abnormality degree calculation means configured to calculate, based on the time series data, an abnormality degree regarding a state of the space object.

One aspect of the calculation method is a calculation method executed by a computer, the calculation method including:
acquiring time series data which represents a luminous intensity of a space object; and
calculating, based on the time series data, an abnormality degree regarding a state of the space object.

One aspect of the storage medium is a storage medium storing a program executed by a computer, the program causing the computer to:
acquire time series data which represents a luminous intensity of a space object; and
calculate, based on the time series data, an abnormality degree regarding a state of the space object.

### EFFECT

An example advantage according to the present disclosure is to suitably calculate a degree of abnormality for detecting a change in a space object.

### BRIEF DESCRIPTION OF THE DRAWINGS

FIG. 1 It illustrates a configuration of an observation system according to a first example embodiment.

FIG. 2 It illustrates an example of the data structure of observation data.

FIG. 3 It illustrates an example of a block configuration of an information processing device.

FIG. 4 It is an example of a functional block diagram regarding an abnormality detection related process.

FIG. 5 It is an example of a functional block diagram of an abnormality degree calculation unit when the abnormality degree calculation model is an autoencoder.

FIG. 6 It illustrates an abnormality degree table according to a first output example.

FIG. 7 It is a diagram showing an outline of a learning process of the abnormality degree calculation model.

FIG. 8 It illustrates an example of a flowchart of the abnormality detection related process.

FIG. 9 It is an example of a functional block diagram regarding the abnormality detection related process according to a modification.

FIG. 10 It is a block diagram of an information processing device according to the second example embodiment.

FIG. 11 It is an example of a flowchart showing a processing procedure in the second example embodiment.

### EXAMPLE EMBODIMENTS

Hereinafter, example embodiments of an information processing device, a calculation method, and a storage medium will be described with reference to the drawings.

### First Example Embodiment

### (1) System Configuration

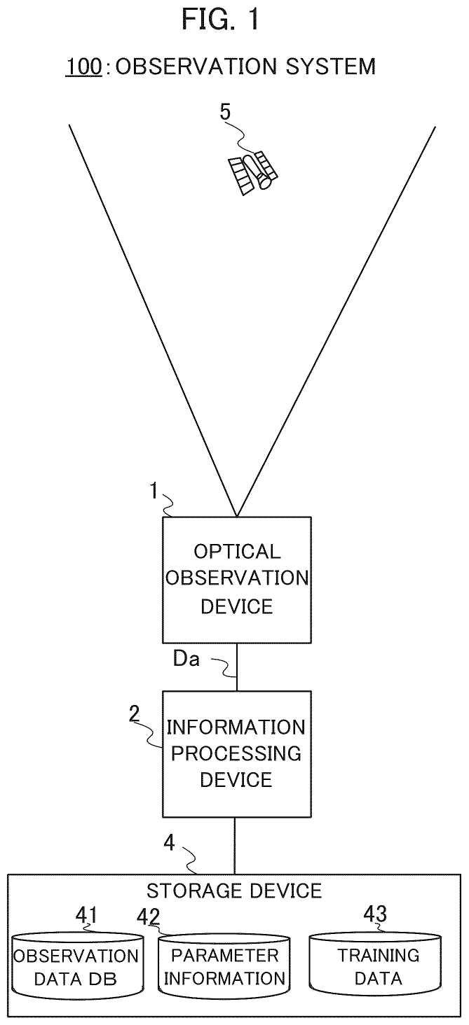

FIG. 1 shows a configuration of an observation system 100 according to the first example embodiment. The observation system 100 mainly includes an optical observation device 1, an information processing device 2, and a storage device 4.

The optical observation device 1 is installed on the ground and optically observes a space object 5 such as a satellite which is a target object of observation existing in the sky. Then, the optical observation device 1 supplies observation data “Da” indicating the observation result regarding the space object 5 to the information processing device 2. The space object 5 is not limited to a satellite, and may be any space object such as space debris. 20

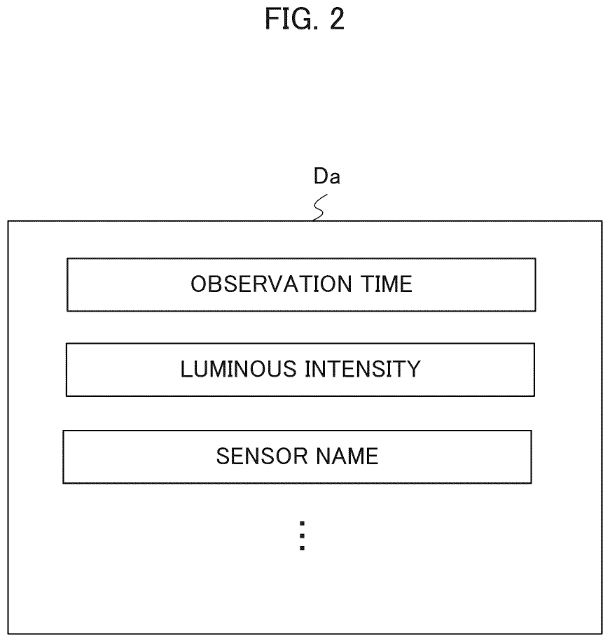

FIG. 2 is an exemplary data structure of the observation data Da. The observation data Da mainly includes information indicating the observation time, luminous intensity, and sensor name, respectively. Here, the “observation time” indicates the observation time (date and time) at which the corresponding luminous intensity was observed, and functions as a time stamp. The “luminous intensity” indicates the luminous intensity (luminance) of the observed space object 5. The “sensor name” indicates the name or ID of the optical observation device 1 or a sensor for observing the luminous intensity provided in the optical observation device 1. It is noted that, since whether or not the space object 5 is observable is affected by the weather or the like, there is a time period in which the space object 5 cannot be observed. Therefore, the observation data Da generated by the optical observation device 1 becomes temporally-discontinuous time series data (i.e., data obtained at observation intervals which are not always constant).

Referring again to FIG. 1, each element of the observation system 100 will be described. The information processing device 2 performs a process (also referred to as “abnormality detection related process”) related to abnormality detection of the space object 5 on the basis of time variation (so-called light curve) in the luminous intensity indicated by the time series observation data Da supplied from the optical observation device 1. Examples of the abnormality of the space object 5 include a change in the posture of the space object 5 or a change in the shape of the space object 5. In the present example embodiment, the information processing device 2 calculates an abnormality degree that indicates the degree of abnormality (or the probability of an occurrence of abnormality) of the space object 5.

The storage device 4 is one or more memories for storing various information necessary for an abnormality detection related process by the information processing device 2. For example, storage device 4 stores observation data DB 41, parameter information 42, and training data 43.

The observation data DB 41 is a database of the observation data Da supplied from the optical observation device 1 to the information processing device 2. Upon receiving the observation data Da from the optical observation device 1, the information processing device 2 adds a record corresponding to the received observation data Da to the observation data DB 41. The observation DB 41 may further include information indicating the processing results by the information processing device 2 such as the abnormality degree calculated by the information processing device 2.

The parameter information 42 indicates parameters of a model (also referred to as “abnormality degree calculation model”) for calculation of the abnormality degree. The abnormality degree calculation model is, for example, a learning model based on machine learning, and it may be a learning model based on a neural network, or may be another type of learning model such as a support vector machine, or may be a combination thereof. In the present example embodiment, as an example, an autoencoder (auto encoder) to be used for anomaly detection or the like is used as the abnormality degree calculation model. In this case, the abnormality degree calculation model is a neural network which is trained to output reconstruction data of input data inputted to the model, wherein time series data indicating the luminous intensity of the space object 5 in a normal state is used as the input data. In this case, the parameter information 42 is information of parameters indicating the weights and the like of the network of the autoencoder, and is obtained by training the autoencoder using the training data 43.

The training data 43 is training data used for learning of the abnormality degree calculation model. For example, if the abnormality degree calculation model is an autoencoder, time series data representing the luminous intensity of the space object 5 in a normal state is stored in the storage device 4 as the training data 43.

The storage device 4 may be an external storage device, such as a hard disk, that is connected or embedded in the information processing device 2, or may be a storage medium, such as a flash memory, that is detachable from the information processing device 2. The storage device 4 may be configured of one or more server devices that perform data communication with the information processing device 2. Any data stored in the storage device 4 may be stored in a dispersed manner by a plurality of devices or storage media.

The configuration of the observation system 100 shown in FIG. 1 is an example, various changes may be made to the configuration. For example, the optical observation device 1 and the information processing device 2 may be configured integrally. Similarly, the information processing device 2 and the storage device 4 may be configured as a single unit. Further, the information processing device 2 may be configured of a plurality of devices. In this case, the plurality of devices constituting the information processing device 2 exchange information necessary to execute the processing allocated in advance with one another. In this case, the information processing device 2 functions as an information processing system.

### (2) Hardware Configuration of Information Processing Device

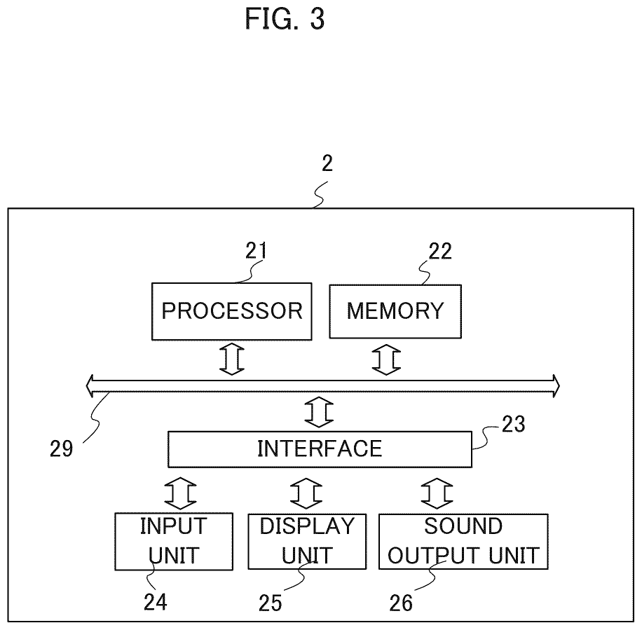

FIG. 3 shows an example of the block configuration of the information processing device 2. The information processing device 2 includes a processor 21, a memory 22, and an interface 23 as hardware. Processor 21, memory 22, and interface 23 are connected via a data bus 29.

The processor 21 executes a predetermined process by executing a program stored in the

memory 22. The processor 21 is a processor such as a CPU (Central Processing Unit), a GPU (Graphics Processing Unit), and a TPU (Tensor Processing Unit). The processor 21 may be configured by a plurality of processors. The processor 21 is an example of a computer.

The memory 22 is configured by various volatile memories and non-volatile memories such as a RAM (Random Access Memory) and a ROM (Read Only Memory). Further, a program for executing various kinds of the process by the information processing device 2 is stored in the memory 22. The memory 22 is used as a working memory to temporarily store information and the like acquired from the storage device 4. The memory 22 may function as the storage device 4. Similarly, the storage device 4 may function as the memory 22 of the information processing device 2. The program executed by the information processing device 2 may be stored in a storage medium other than the memory 22.

The interface 23 is one or more interfaces for electrically connecting the information processing device 2 to other devices by wired or wirelessly. Examples of the interfaces include a wireless interface, such as a network adapter, for transmitting and receiving data to and from other devices wirelessly, and a hardware interface, such as a cable, for connecting to other devices. In the present example embodiment, the interface 23 performs the interface operation of the input unit 24, the display unit 25, and the sound output unit 26 which are included in the information processing device 2.

The input unit 24 is a user interface for the user of the observation system 100 to input predetermined information, and examples thereof include, a button, a switch, a touch panel, and a voice input device. The display unit 25 is, for example, a display or a projector, and displays predetermined information under the control of the processor 21. The sound output unit 26 is, for example, a speaker, and outputs sound under the control of the processor 21. Each of the input unit 24, the display unit 25, the sound output unit 26 may be an external device that is electrically connected by wire or wirelessly via the interface 23 to the information processing device 2. The interface 23 may perform an interface operation of any device other than the input unit 24, the display unit 25, and the sound output unit 26.

### (3) Functional Blocks

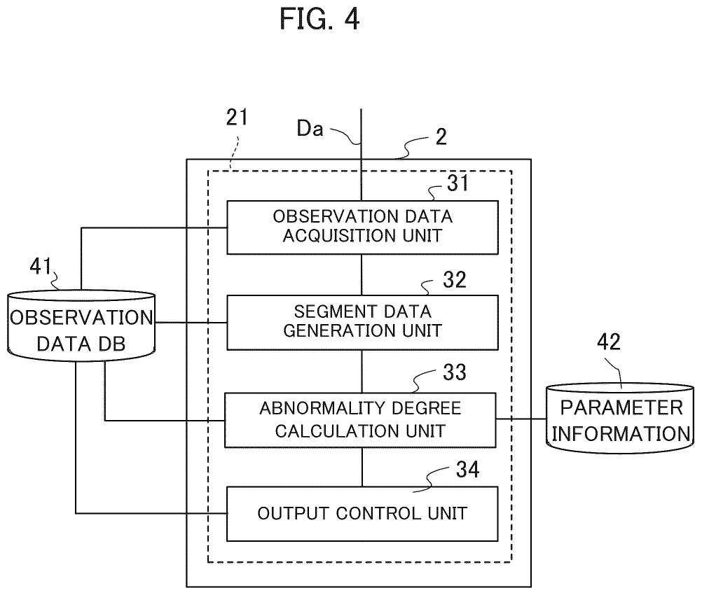

FIG. 4 is an example of a functional block related to abnormality detection related process. The processor 21 of the information processing device 2 functionally includes an observation data acquisition unit 31, a segment data generation unit 32, an abnormality degree calculation unit 33, and an output control unit 34 in relation to the abnormality detection related process. In FIG. 4, blocks for transmitting and receiving data with each other are connected by a solid line, but the combination of blocks for transmitting and receiving data with each other is not limited thereto. The same applies to the drawings of other functional blocks described below.

The observation data acquisition unit 31 acquires the observation data Da indicating the observation result of the space object 5 from the optical observation device 1 through the interface 23. Then, the observation data acquisition unit 31 stores the acquired observation data Da in the observation data DB 41. In addition to storing the observation data Da in the observation data DB 41, or in place of that process, the observation data acquisition unit 31 may supply the observation data Da to the segment data generation unit 32.

The segment data generation unit 32 generates segment data based on the time series observation data Da acquired by the observation data acquisition unit 31. The segment data herein indicates observed values of the luminous intensity and position and observed times of the space object 5 observed in time series during a certain time period, and is generated by the observed data Da corresponding to a predetermined number of the observed times. The predetermined number described above may be a predetermined constant or may be a variable number. The segment data generation unit 32 supplies the generated segment data to the abnormality degree calculation unit 33.

A supplementary description will be given of the case where the predetermined number described above is a variable number. For example, the segment data generation unit 32 segments (divides) the time series observation data Da so as to mark the boundaries at discontinuous timings (e.g., any timing when unobserved duration becomes equal or larger than a predetermined time length) of the observation of the space object 5 by the optical observation device 1. Then, for each group of the segmented observation data Da, the segment data generation unit 32 generates segment data. According to this approach, the segment data generation unit 32 can determine each segment data to be a group of the observation data Da with similar observation times. Thus, it is possible to improve the accuracy of the abnormality degree. Also in this case, the upper limit number of pieces of the observation data Da to be included in a single piece of segment data may be determined in advance.

On the basis of the segment data generated by the segment data generation unit 32, the abnormality degree calculation unit 33 calculates the abnormality degree of the space object 5 at the time when the luminous intensity indicated by the segment data is observed. In this case, the abnormality degree calculation unit 33 configures the abnormality degree calculation model based on the parameter information 42 and calculates the abnormality degree based on the information outputted by the abnormality degree calculation model in response to the input of the segment data to the abnormality degree calculation model. Specific examples of the process executed by the abnormality degree calculation unit 33 will be described later. The abnormality degree calculation unit 33 supplies the information on the calculated abnormality degree to the output control unit 34. The abnormality degree calculation unit 33 may record the calculated information regarding the abnormality degree in the observation data DB 41.

The output control unit 34 controls the output related to the abnormality degree calculated by the abnormality degree calculation unit 33. In the first output example, the output control unit 34 performs control to display information on the abnormality degree calculated by the abnormality degree calculation unit 33 on the display unit 25. In the second output example, the output control unit 34 detects the presence or absence of abnormality of the space object 5 based on the degree of abnormality, and then outputs information based on the detection result by the display unit 25 or the sound output unit 26. In this case, the output control unit 34 supplies a display signal based on the detection result to the display unit 25 via the interface 23 to thereby display a predetermined information on the display unit 25, and/or, supplies a sound output signal based on the detection result to the sound output unit 26 via the interface 23 to thereby output a sound or voice by the sound output unit 26. Details of the process that the output control unit 34 executes will be described later. The output control unit 34 is an example of “display means” and “alert means”.

Each component of the observation data acquisition unit 31, the segment data generation unit 32, the abnormality degree calculation unit 33, and the output control unit 34 described in FIG. 4 can be realized, for example, by the processor 21 executing a program. In addition, the necessary program may be recorded in any non-volatile storage medium and installed as necessary to realize the respective components. In addition, at least a part of these components is not limited to being realized by a software program and may be realized by any combination of hardware, firmware, and software. At least some of these components may also be implemented using user-programmable integrated circuitry, such as FPGA (Field-Programmable Gate Array) and microcontrollers. In this case, the integrated circuit may be used to realize a program for configuring each of the above-described components. Further, at least a part of the components may be configured by a ASSP (Application Specific Standard Produce), ASIC (Application Specific Integrated Circuit) and/or a quantum processor (quantum computer control chip). In this way, each component may be implemented by a variety of hardware. The above is true for other example embodiments to be described later. Further, each of these components may be realized by the collaboration of a plurality of computers, for example, using cloud computing technology.

### (4) Abnormality Calculation Unit

Next, a specific example of the process by the abnormality degree calculation unit 33 will be described.

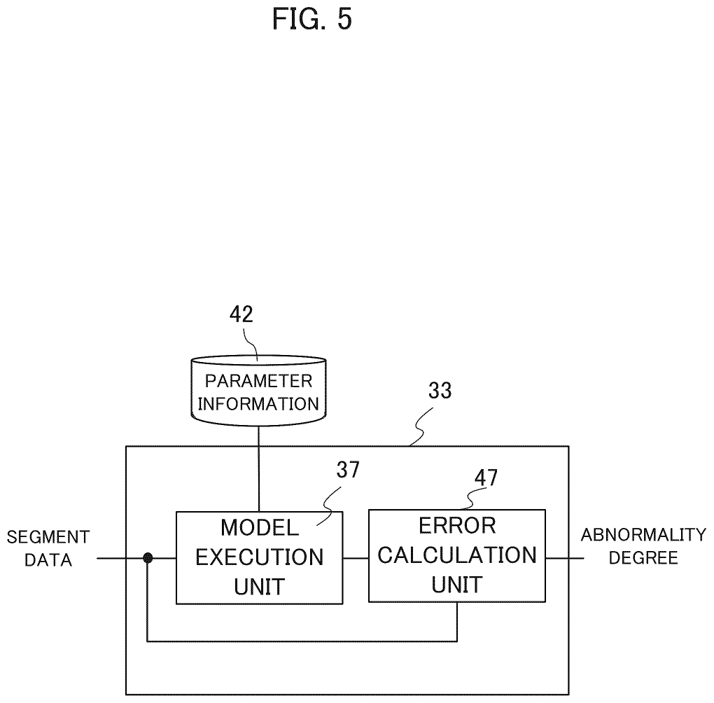

FIG. 5 is an example of the functional block diagram of the abnormality degree calculation unit 33 when the abnormality degree calculation model is an autoencoder. The abnormality degree calculation unit 33 functionally includes a model execution unit 37 and an error calculation unit 47.

The model execution unit 37 configures an abnormality degree calculation model that is an autoencoder based on the parameter information 42 and acquires data outputted by the abnormality degree calculation model in response to input of segment data supplied from the segment data generation unit 32 to the abnormality degree calculation model. In this case, the abnormality degree calculation model is trained to output reconstructed data (also referred to as “reconstruction data”) of the inputted segment data in response to the input of segment data indicating the luminous intensity of the space object 5 in a normal state to the model. Therefore, the model execution unit 37 supplies the reconstruction data outputted by the abnormality degree calculation model to the error calculation unit 47.

The error calculation unit 47 calculates, as the abnormality degree, the error (so-called reconstruction error) between the reconstruction data supplied from the model execution unit 37 and the segment data that is the input data to the abnormality degree calculation model. In this case, the error calculation unit 47 may calculate the above-described error using an arbitrary loss function used in machine learning or the like. For example, the error calculation unit 47 calculates, as the abnormality degree, the L1 norm or L2 norm of the difference vector between the input data and the reconstruction data. Then, the error calculation unit 47 outputs the calculated abnormality degree.

As described above, the abnormality degree calculation unit 33 can suitably calculate the abnormality degree, which is an index indicating the probability of occurrence of the change in the posture and the like of the space object 5, by using the abnormality degree calculation model that is an autoencoder that has already been trained.

### (5) Output Control

Next, a specific example of the processing of the output control unit 34 will be described.

In the first output example, the output control unit 34 controls the display unit 25 to display information on the abnormality degree calculated by the abnormality degree calculation unit 33. In this case, the output control unit 34 may display a graph or a table indicating the transition of the abnormality degree in time series calculated by the abnormality degree calculation unit 33 on the display unit 25.

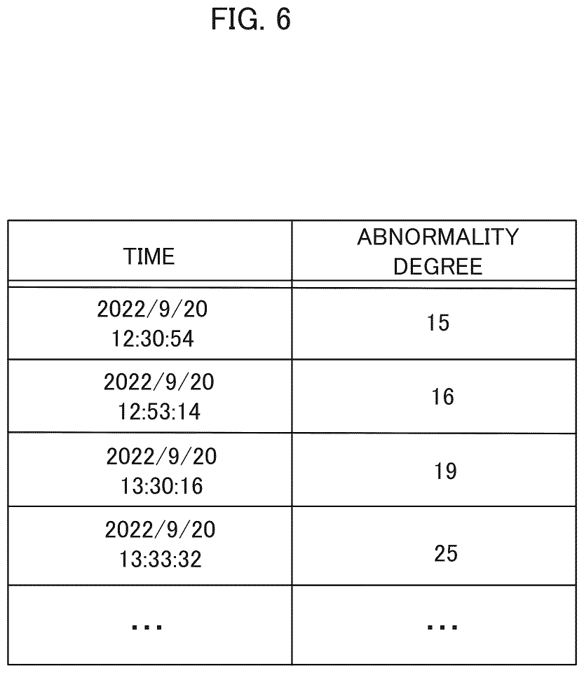

FIG. 6 is an example of a table showing the transition of the abnormality degree outputted by the output control unit 34 in the first output example. The table shown in FIG. 6 is provided with items “time” and “abnormality degree” and includes, for example, records generated for respective pieces of segment data generated by the segment data generation unit 32.

The item “time” indicates the representative time of the observation times of the luminous intensity included in the corresponding piece of segment data. In this case, the output control unit 34 may determine the representative time based on any rule from a plurality of observation times corresponding to a plurality of luminous intensity included in the corresponding piece of segment data. For example, the output control unit 34 may set the earliest or latest time of the above-described plurality of observation times as the representative time, or may set the central value of the above-described plurality of observation times as the representative time. The output control unit 34 may provide, instead of the item “time”, the item “time period” indicating the time period from the earliest time to the latest time among the plurality of observation times described above as an item of the table.

The item “abnormality degree” indicates the abnormality degree calculated from the corresponding piece of segment data. The output control unit 34 may highlight a record in which the abnormality degree is equal to or more than a predetermined threshold value as a record indicating the abnormality-suspected observation result of the space object 5.

According to the first output example, the user can suitably use the abnormality degree presented by the information processing device 2 as an indication for determining whether or not there is an abnormality in the space object 5.

In the second output example, the output control unit 34 detects the presence or absence of abnormality of the space object 5 based on the abnormality degree, and outputs the abnormality detection result by the display unit 25 or the sound output unit 26. For example, if the abnormality degree calculated by the abnormality degree calculation unit 33 based on the latest piece of segment data generated by the segment data generation unit 32 reaches a predetermined threshold value or more, the output control unit 34 outputs an alert indicating that an abnormality has occurred in the space object 5 by the display unit 25 or the sound output unit 26. The above-mentioned threshold value is, for example, stored in the memory 22 or storage device 4 in advance. In another example, on the basis of the abnormality degree in time series, the output control unit 34 recognizes an abnormality period in which an abnormality has occurred in the space object 5 and any other normal period, and then clearly indicates the abnormality period and the normal period on the graph or the table representing the abnormality degree by color coding or the like, respectively.

According to the second output example, the information processing device 2 autonomously conducts abnormality detection of the space object 5 and suitably notifies the user of the abnormality detection result.

In the second output example, instead of outputting the abnormality detection result by the display unit 25 or the sound output unit 26, the output control unit 34 may store the abnormality detection result in the storage device 4, or may transmit the state of the space object 5 to another device (which may be a terminal or the like used by the manager).

### (6) Learning Process

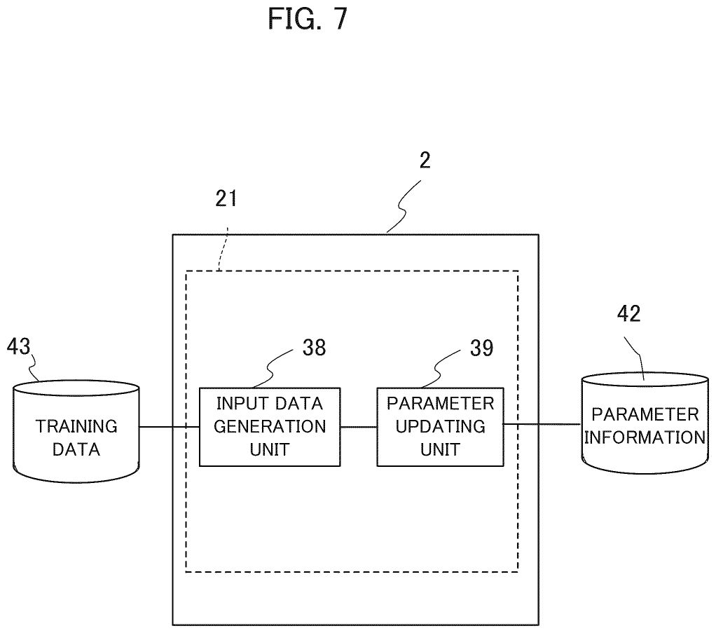

Next, the learning process of the abnormality degree calculation model will be supplementally described. FIG. 7 is a diagram illustrating an outline of a learning process of the abnormality degree calculation model by the information processing device 2. In the learning process, the processor 21 of the information processing device 2 is equipped with an input data generation unit 38 and a parameter updating unit 39.

On the basis of the training data 43 indicating the time series luminous intensity of the space object 5 in the normal state, the input data generation unit 38 generates data which conforms to the input format of the abnormality degree calculation model. For example, the input data generation unit 38 generates segment data from the training data 43 by performing the same process as the segment data generation unit 32 does. in another example, if plural pieces of segment data matched with the input format of the abnormality degree calculation model have already been stored as the training data 43, the input data generation unit 38 extracts a piece of segment data to be inputted to the abnormality degree calculation model from the training data 43 in order.

The parameter updating unit 39 inputs the data supplied from the input data generation

unit 38 to the abnormality degree calculation model as the input data and calculates a reconstruction error between the data outputted from the abnormality degree calculation model and the input data. The parameter updating unit 39 determines the parameters of the abnormality degree calculation model by the gradient descent method, the error back propagation method, or the like so that the reconstruction error is minimized. The parameter updating unit 39 updates the parameter information 42 according to the determined parameters.

The learning process of the abnormality degree calculation model may be executed by a device other than the information processing device 2. In this case, a device other than the information processing device 2 executes the learning process described above before the execution of the abnormality detection related process by the information processing device 2, and the parameter information 42 obtained by the learning process is stored in the storage device 4.

### (7) Processing Flow

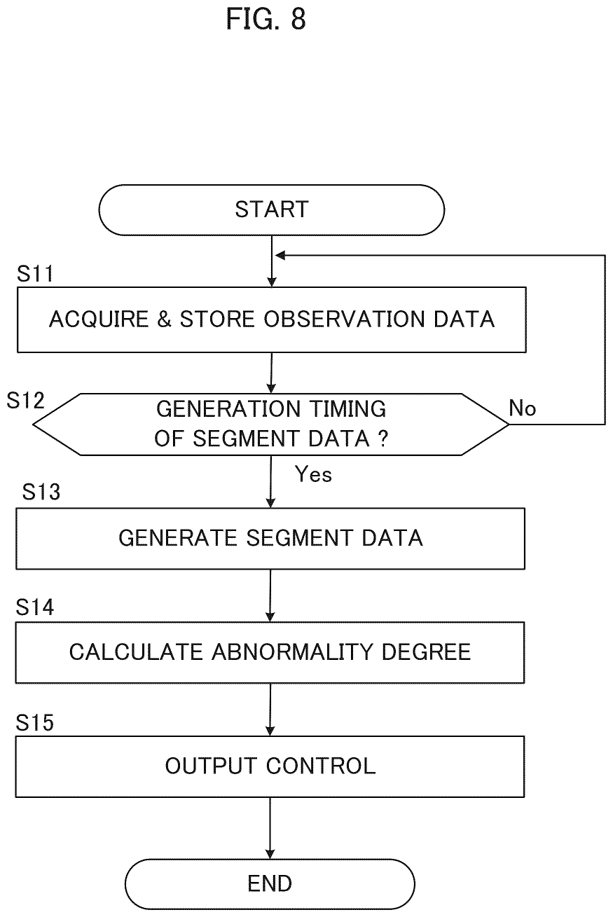

FIG. 8 is an example of a flowchart of the abnormality detection related process. The information processing device 2 repeatedly executes the process of the flowchart shown in FIG. 8.

First, the information processing device 2 acquires the observation data Da from the optical observation device 1, and stores the acquired observation data Da in the observation data DB 41 (step S11).

Next, the information processing device 2 determines whether or not the generation timing of the segment data comes up (step S12). For example, upon determining that a predetermined necessary number of pieces of observation data Da, which are required to generate the segment data, are accumulated, the information processing device 2 determines that the generation timing of the segment data has come up. In another example, upon detecting that an interval of acquiring the observation data Da is equal or longer than a predetermined interval, the information processing device 2 determines that the generation timing of the segment data has come up and generates the segment data based on the observation data Da immediately before the acquisition interval is equal to or longer than the predetermined interval. In yet another example, upon detecting an external input (including a user input by the input unit 24) requesting the output of the information regarding the abnormality degree, the information processing device 2 generates segment data based on the observation data Da stored in the observation data DB 41. In this case, if the information specifying a time period is included in the external input, the information processing device 2 may extract the observation data Da corresponding to the specified time period from the observation data DB 41 and generate the segment data based on the extracted observation data Da.

Upon determining that the generation timing of the segment data has come up (step S12; Yes), the information processing device 2 generates the segment data based on the observation data Da acquired at step S11 (step S13). On the other hand, upon determining that the generation timing of the segment data does not come up (step S12; No), the information processing device 2 performs the processes at step S11 and step S12 again.

After generation of the segment data, the information processing device 2 calculates the abnormality degree of the space object 5 based on the generated segment data (step S14). In this case, the information processing device 2 calculates the abnormality degree, based on data outputted by the abnormality degree calculation model in response to the input of the segment data to the abnormality degree calculation model, which is configured by the parameter information 42.

Then, the information processing device 2 performs output control related to the abnormality degree calculated at step S14 (step S15). In this case, for example, the information processing device 2 displays the transition of the abnormality degree in time series or detects the presence or absence of abnormality of the space object 5 based on the abnormality degree to display or output the detection result.

### (8) Modifications

A description will be given of preferred modifications to the example embodiment described above. The following modifications may be applied to the above-described example embodiment in any combination.

### First Modification

The information processing device 2 may convert the segment data into feature data representing features by performing the feature extraction process or by adding the lag features. In this case, the feature data becomes data in a predetermined tensor format which conforms to the input format of the abnormality degree calculation model.

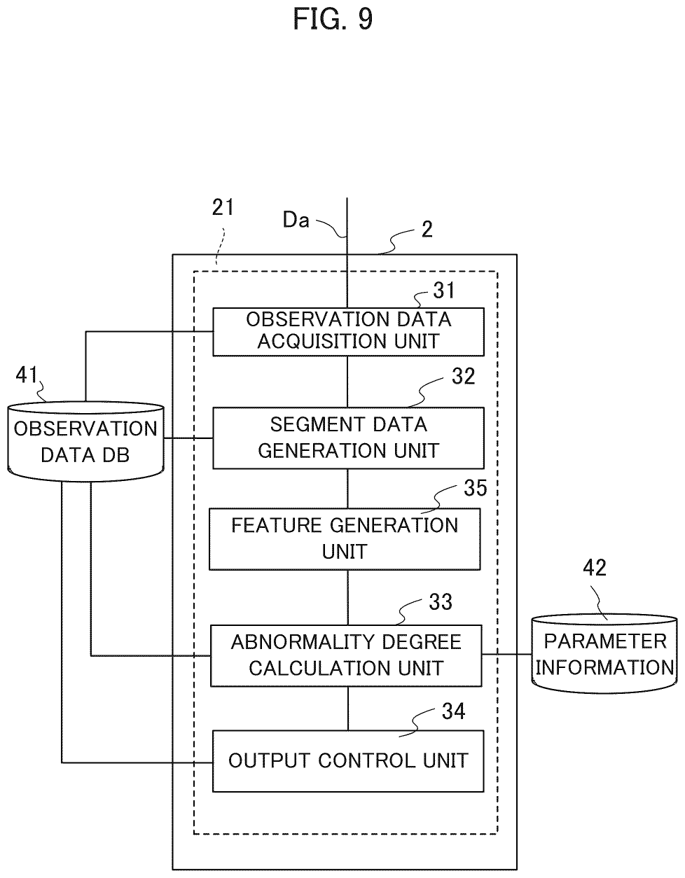

FIG. 9 is an example of a functional block diagram related to the abnormality detection related process of the processor 21 of the information processing device 2 according to this modification. The processor 21 includes a feature generation unit 35 in addition to the processing units 31 to 34 shown in FIG. 4. The feature generation unit 35 converts the segment data generated by the segment data generation unit 32 into the feature data matching the input format of the abnormality degree calculation model. In this case, the feature generation unit 35 may generate the feature data from the segment data based on any feature extraction technique. The feature generation unit 35 may generate the feature data obtained by adding the lag features to the segment data or the features thereof. In some embodiments, the lag features are generated based on a predetermined number of pieces of segment data generated immediately before the target piece of segment data. Then, the feature generation unit 35 supplies the generated feature data to the abnormality degree calculation unit 33. Thereafter, the abnormality degree calculation unit 33 calculates the abnormality degree based on the data outputted by the abnormality degree calculation model in response to the input of the feature data to the abnormality degree calculation model.

According to this modification, the information processing device 2 can perform calculation of the abnormality degree with higher accuracy.

### Second Modification

The abnormality degree calculation model may be a model other than an autoencoder. For example, the abnormality degree calculation model may be a model configured to convert the input data into data in the feature space with a predetermined number of dimensions. In this case, for example, data (i.e., normal data) in the above-described feature space in the case where the space object 5 is in a normal state is stored in advance in the storage device 4 or the like, and the information processing device 2 calculates, as the abnormality degree, an error between the data outputted by the abnormality degree calculation model and the normal data.

In this way, even if the abnormality degree calculation model other than an autoencoder is used, the information processing device 2 can suitably calculate the abnormality degree.

### Second Example Embodiment

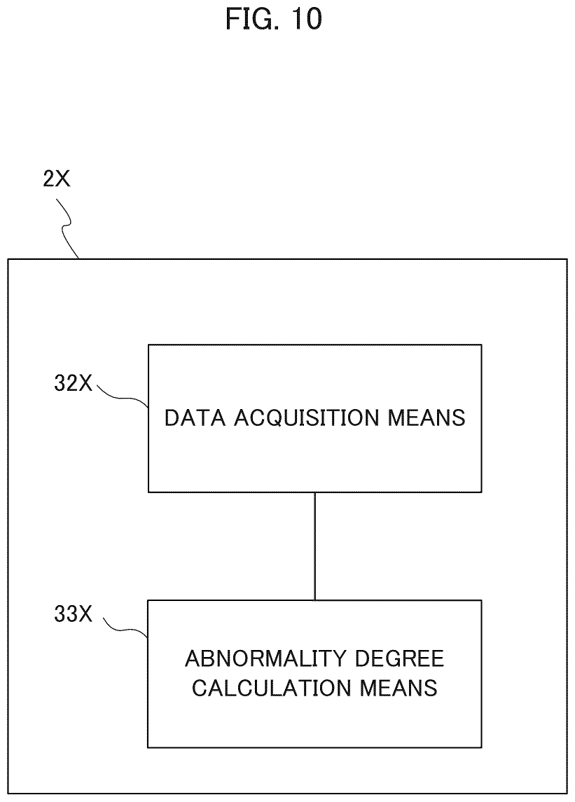

FIG. 10 is a block diagram of an information processing device 2X according to a second example embodiment. The information processing device 2X includes a data acquisition means 32X and an abnormality degree calculation means 33X. The information processing device 2X may be configured of a plurality of devices.

The data acquisition means 32X is configured to acquire time series data which represents a luminous intensity of a space object. Examples of the data acquisition means 32X include the observation data acquisition unit 31 and the segment data generation unit 32 in the first example embodiment (including modifications, hereinafter the same.).

The abnormality degree calculation means 33X is configured to calculate, based on the time series data, an abnormality degree regarding a state of the space object. Examples of the abnormality degree calculation means 33X include the abnormality degree calculation unit 33 according to the first example embodiment.

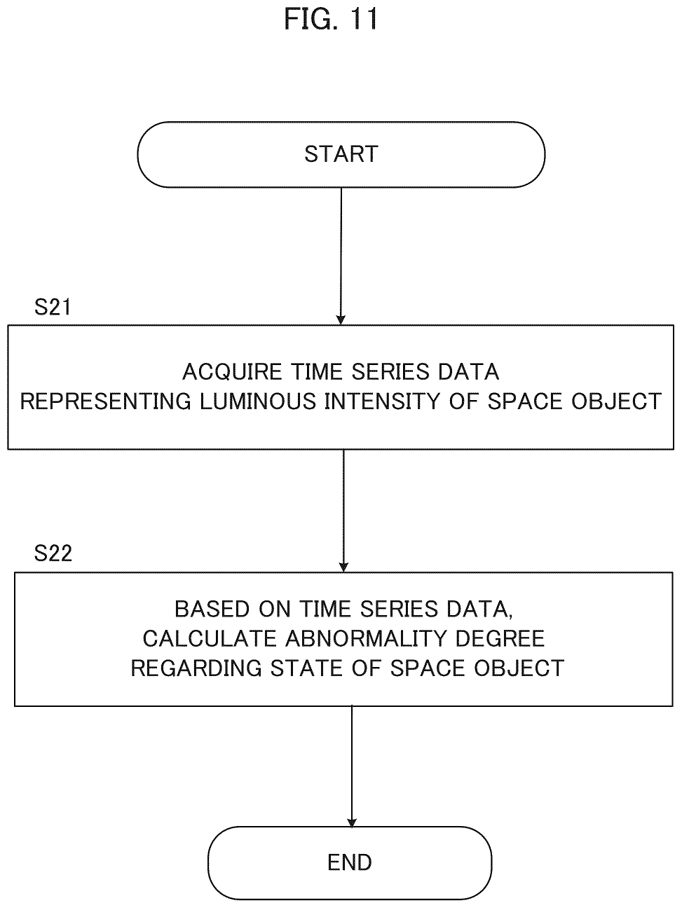

FIG. 11 is an example of a flowchart showing a processing procedure in the second example embodiment. First, the data acquisition means 32X acquires time series data which represents a luminous intensity of a space object (step S21). The abnormality degree calculation means 33X calculates, based on the time series data, an abnormality degree regarding a state of the space object (step S22).

According to the second example embodiment, the information processing device 2X can suitably calculate the abnormality degree regarding the state of a space object.

In the example embodiments described above, the program is stored by any type of a non-transitory computer-readable medium (non-transitory computer readable medium) and can be supplied to a control unit or the like that is a computer. The non-transitory computer-readable medium include any type of a tangible storage medium. Examples of the non-transitory computer readable medium include a magnetic storage medium (e.g., a flexible disk, a magnetic tape, a hard disk drive), a magnetic-optical storage medium (e.g., a magnetic optical disk), CD-ROM (Read Only Memory), CD-R, CD-R/W, a solid-state memory (e.g., a mask ROM, a PROM (Programmable ROM), an EPROM (Erasable PROM), a flash ROM, a RAM (Random Access Memory)). The program may also be provided to the computer by any type of a transitory computer readable medium. Examples of the transitory computer readable medium include an electrical signal, an optical signal, and an electromagnetic wave. The transitory computer readable medium can provide the program to the computer through a wired channel such as wires and optical fibers or a wireless channel.

The whole or a part of the example embodiments described above can be described as, but not limited to, the following Supplementary Notes.

### Supplementary Note 1

An information processing device comprising:
a data acquisition means configured to acquire time series data which represents a luminous intensity of a space object; and
an abnormality degree calculation means configured to calculate, based on the time series data, an abnormality degree regarding a state of the space object.

### Supplementary Note 2

The information processing device according to Supplementary Note 1,
wherein the abnormality degree calculation means is configured to calculate the abnormality degree, based on the time series data and a learning model, and
wherein the learning model is a model trained to output reconstruction data of an input to the learning model, based on training data representing the luminous intensity of the space object in a normal state.

### Supplementary Note 3

The information processing device according to Supplementary Note 1 or 2, further comprising
an abnormality detection means configured to detect an abnormality of the space object based on the abnormality degree.

### Supplementary Note 4

The information processing device according to any one of Supplementary Notes 1 to 3,
wherein the data acquisition means is configured to acquire, as the time series data, segment data obtained by segmenting the luminous intensity, which is observed in time series, into data representing a predetermined number of the luminous intensity, and
wherein the abnormality degree calculation means is configured to calculate the abnormality degree based on the segment data.

### Supplementary Note 5

The information processing device according to any one of Supplementary Notes 1 to 3,
wherein the data acquisition means is configured to acquire, as the time series data, segment data obtained by segmenting the luminous intensity, which is observed in time series, in accordance with observation intervals, and
wherein the abnormality degree calculation means is configured to calculate the abnormality degree based on the segment data.

### Supplementary Note 6

The information processing device according to any one of Supplementary Notes 1 to 5, further comprising a display means configured to display information on the abnormality degree.

### Supplementary Note 7

The information processing device according to Supplementary Note 6,
wherein the display means is configured to display information indicating a transition of the abnormality degree.

### Supplementary Note 8

The information processing device according to any one of Supplementary Notes 1 to 7, further comprising
an alert means configured to alert an occurrence of an abnormality of the space object, upon detecting the abnormality detected based on the abnormality degree.

### Supplementary Note 9

A calculation method executed by a computer, the calculation method comprising:
acquiring time series data which represents a luminous intensity of a space object; and
calculating, based on the time series data, an abnormality degree regarding a state of the space object.

### Supplementary Note 10

A storage medium storing a program executed by a computer, the program causing the computer to:
acquire time series data which represents a luminous intensity of a space object; and
calculate, based on the time series data, an abnormality degree regarding a state of the space object.

### Supplementary Note 11

An information processing system comprising:
a data acquisition means configured to acquire time series data which represents a luminous intensity of a space object; and
an abnormality degree calculation means configured to calculate, based on the time series data, an abnormality degree regarding a state of the space object.

### Supplementary Note 12

The information processing system according to Supplementary Note 11,
wherein the abnormality degree calculation means is configured to calculate the abnormality degree, based on the time series data and a learning model, and
wherein the learning model is a model trained to output reconstruction data of an input to the learning model, based on training data representing the luminous intensity of the space object in a normal state.

### Supplementary Note 13

The information processing system according to Supplementary Note 11 or 12, further comprising
an abnormality detection means configured to detect an abnormality of the space object based on the abnormality degree.

### Supplementary Note 14

The information processing system according to any one of Supplementary Notes 11 to 13,
wherein the data acquisition means is configured to acquire, as the time series data, segment data obtained by segmenting the luminous intensity, which is observed in time series, into data representing a predetermined number of the luminous intensity, and
wherein the abnormality degree calculation means is configured to calculate the abnormality degree based on the segment data.

### Supplementary Note 15

The information processing system according to any one of Supplementary Notes 11 to 13,
wherein the data acquisition means is configured to acquire, as the time series data, segment data obtained by segmenting the luminous intensity, which is observed in time series, in accordance with observation intervals, and
wherein the abnormality degree calculation means is configured to calculate the abnormality degree based on the segment data.

### Supplementary Note 16

The information processing system according to any one of Supplementary Notes 11 to 15, further comprising a display means configured to display information on the abnormality degree.

### Supplementary Note 17

The information processing system according to Supplementary Note 16,
wherein the display means is configured to display information indicating a transition of the abnormality degree.

### Supplementary Note 18

The information processing system according to any one of Supplementary Notes 11 to 17, further comprising
an alert means configured to alert an occurrence of an abnormality of the space object, upon detecting the abnormality detected based on the abnormality degree.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. All Patent and Non-Patent Literatures mentioned in this specification are incorporated by reference in its entirety.

### DESCRIPTION OF REFERENCE NUMERALS

1 Optical observation device
2 Information processing device
4 Storage device
21 Processor
22 Memory
23 Interface
24 Input unit
25 Display unit
26 Sound output unit
41 Observation data DB
42 Parameter information
43 Training data
100 Observation system

What is claimed is:

1. An information processing device comprising:
at least one memory configured to store instructions; and
at least one processor configured to execute the instructions to:
acquire time series data which represents a luminous intensity of a space object; and
calculate, based on the time series data, an abnormality degree regarding a state of the space object.

2. The information processing device according to claim 1,
wherein the at least one processor is configured to execute the instructions calculate the abnormality degree, based on the time series data and a learning model, and
wherein the learning model is a model trained to output reconstruction data of an input to the learning model, based on training data representing the luminous intensity of the space object in a normal state.

3. The information processing device according to claim 1,
wherein the at least one processor is configured to further execute the instructions to detect an abnormality of the space object based on the abnormality degree.

4. The information processing device according to claim 1,
wherein the at least one processor is configured to execute the instructions to acquire, as the time series data, segment data obtained by segmenting the luminous intensity, which is observed in time series, into data representing a predetermined number of the luminous intensity, and
wherein the at least one processor is configured to execute the instructions to calculate the abnormality degree based on the segment data.

5. The information processing device according to claim 1,
wherein the at least one processor is configured to execute the instructions to acquire, as the time series data, segment data obtained by segmenting the luminous intensity, which is observed in time series, in accordance with observation intervals, and
wherein the at least one processor is configured to execute the instructions to calculate the abnormality degree based on the segment data.

6. The information processing device according to claim 1,
wherein the at least one processor is configured to further execute the instructions to display information on the abnormality degree.

7. The information processing device according to claim 6,
wherein the at least one processor is configured to execute the instructions to display information indicating a transition of the abnormality degree.

8. The information processing device according to claim 1,
wherein the at least one processor is configured to further execute the instructions to alert an occurrence of an abnormality of the space object, upon detecting the abnormality detected based on the abnormality degree.

9. A calculation method executed by a computer, the calculation method comprising:
acquiring time series data which represents a luminous intensity of a space object; and
calculating, based on the time series data, an abnormality degree regarding a state of the space object.

10. A non-transitory computer readable storage medium storing a program executed by a computer, the program causing the computer to:
acquire time series data which represents a luminous intensity of a space object; and
calculate, based on the time series data, an abnormality degree regarding a state of the space object.
